(19) United States
(12) Patent Application Publication
(10) Pub. No.: US 2026/0128842 A1
(43) Pub. Date: May 7, 2026

(54) TRANSMISSION CONFIGURATION INDICATOR STATE IDENTIFIER SIGNALING FOR CONDITIONAL LOWER LAYER TRIGGERED MOBILITY

(71) Applicant: QUALCOMM Incorporated, San Diego, CA (US)

(72) Inventors: Doohyun SUNG, Basking Ridge, NJ (US); Jelena DAMNJANOVIC, Del Mar, CA (US)

(21) Appl. No.: 19/336,246

(22) Filed: Sep. 22, 2025

Related U.S. Application Data
(60) Provisional application No. 63/716,487, filed on Nov. 5, 2024.

(51) Int. Cl. H04L 5/00; H04W 72/231

(52) U.S. Cl. CPC H04L 5/0091; H04W 72/231

(57) ABSTRACT

In some implementations, a user equipment (UE) may transmit at least one of a transmission configuration indicator (TCI) state activation/deactivation request message or a TCI state activation/deactivation notification message. The UE may activate or deactivate at least one TCI state associated with a conditional lower layer triggered mobility procedure based at least in part on the at least one of the TCI state activation/deactivation request message or the TCI state activation/deactivation notification message.

### CROSS-REFERENCE TO RELATED APPLICATION

This Patent Application claims priority to U.S. Provisional Patent Application No. 63/716,487, filed on November 5, 2024, entitled “TRANSMISSION CONFIGURATION INDICATOR STATE IDENTIFIER SIGNALING FOR CONDITIONAL LOWER LAYER TRIGGERED MOBILITY,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with transmission configuration indicator state identifier signaling for conditional lower layer triggered mobility.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include transmitting at least one of a transmission configuration indicator (TCI) state activation/deactivation request message or a TCI state activation/deactivation notification message. The method may include activating or deactivating at least one TCI state associated with a conditional lower layer triggered mobility (C-LTM) procedure based at least in part on the at least one of the TCI state activation/deactivation request message or the TCI state activation/deactivation notification message.

Some aspects described herein relate to a method of wireless communication performed by a network node. The method may include receiving, from a UE, at least one of a TCI state activation/deactivation request message or a TCI state activation/deactivation notification message, where the at least one of the TCI state activation/deactivation request message or the TCI state activation/deactivation notification message is associated with the UE activating or deactivating at least one TCI state associated with a C-LTM procedure. The method may include transmitting, in response to receiving the at least one of the TCI state activation/deactivation request message or the TCI state activation/deactivation notification message, a TCI state activation/deactivation medium access control (MAC) control element (MAC-CE) associated with the UE activating or deactivating the at least one TCI state associated with the C-LTM procedure.

Some aspects described herein relate to a UE for wireless communication. The UE may include one or more memories and one or more processors coupled to the one or more memories. The one or more processors may be configured, individually or in any combination, to transmit at least one of a TCI state activation/deactivation request message or a TCI state activation/deactivation notification message. The one or more processors may be configured, individually or in any combination, to activate or deactivate at least one TCI state associated with a C-LTM procedure based at least in part on the at least one of the TCI state activation/deactivation request message or the TCI state activation/deactivation notification message.

Some aspects described herein relate to a network node for wireless communication. The network node may include one or more memories and one or more processors coupled to the one or more memories. The one or more processors may be configured, individually or in any combination, to receive, from a UE, at least one of a TCI state activation/deactivation request message or a TCI state activation/deactivation notification message, where the at least one of the TCI state activation/deactivation request message or the TCI state activation/deactivation notification message is associated with the UE activating or deactivating at least one TCI state associated with a C-LTM procedure. The one or more processors may be configured, individually or in any combination, to transmit, in response to receiving the at least one of the TCI state activation/deactivation request message or the TCI state activation/deactivation notification message, a TCI state activation/deactivation MAC-CE associated with the UE activating or deactivating the at least one TCI state associated with the C-LTM procedure.

Some aspects described herein relate to a non-transitory computer-readable medium that stores a set of instructions for wireless communication by a UE. The set of instructions, when executed by one or more processors of the UE, may cause the UE to transmit at least one of a TCI state activation/deactivation request message or a TCI state activation/deactivation notification message. The set of instructions, when executed by one or more processors of the UE, may cause the UE to activate or deactivate at least one TCI state associated with a C-LTM procedure based at least in part on the at least one of the TCI state activation/deactivation request message or the TCI state activation/deactivation notification message.

Some aspects described herein relate to a non-transitory computer-readable medium that stores a set of instructions for wireless communication by a network node. The set of instructions, when executed by one or more processors of the network node, may cause the network node to receive, from a UE, at least one of a TCI state activation/deactivation request message or a TCI state activation/deactivation notification message, where the at least one of the TCI state activation/deactivation request message or the TCI state activation/deactivation notification message is associated with the UE activating or deactivating at least one TCI state associated with a C-LTM procedure. The set of instructions, when executed by one or more processors of the network node, may cause the network node to transmit, in response to receiving the at least one of the TCI state activation/deactivation request message or the TCI state activation/deactivation notification message, a TCI state activation/deactivation MAC-CE associated with the UE activating or deactivating the at least one TCI state associated with the C-LTM procedure.

Some aspects described herein relate to an apparatus for wireless communication. The apparatus may include means for transmitting at least one of a TCI state activation/deactivation request message or a TCI state activation/deactivation notification message. The apparatus may include means for activating or deactivating at least one TCI state associated with a C-LTM procedure based at least in part on the at least one of the TCI state activation/deactivation request message or the TCI state activation/deactivation notification message.

Some aspects described herein relate to an apparatus for wireless communication. The apparatus may include means for receiving, from a UE, at least one of a TCI state activation/deactivation request message or a TCI state activation/deactivation notification message, where the at least one of the TCI state activation/deactivation request message or the TCI state activation/deactivation notification message is associated with the UE activating or deactivating at least one TCI state associated with a C-LTM procedure. The apparatus may include means for transmitting, in response to receiving the at least one of the TCI state activation/deactivation request message or the TCI state activation/deactivation notification message, a TCI state activation/deactivation MAC-CE associated with the UE activating or deactivating the at least one TCI state associated with the C-LTM procedure.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIGS. 3A-3C are diagrams illustrating examples associated with lower layer triggered mobility (LTM) procedures, in accordance with the present disclosure.

FIG. 4 is a diagram of an example associated with transmission configuration indicator state identifier signaling for conditional LTM, in accordance with the present disclosure.

FIG. 5 is a diagram illustrating an example process performed, for example, at a user equipment (UE) or an apparatus of a UE, in accordance with the present disclosure.

FIG. 6 is a diagram illustrating an example process performed, for example, at a network node or an apparatus of a network node, in accordance with the present disclosure.

FIG. 7 is a diagram of an example apparatus for wireless communication, in accordance with the present disclosure.

FIG. 8 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In certain cell-switch procedures, a user equipment (UE) may be configured to trigger a switch to a candidate target cell, such as in response to detecting that a certain condition has been met. For example, a UE may be configured to perform a conditional lower layer triggered mobility (C-LTM) procedure. In a C-LTM procedure, the UE may identify (e.g., via dynamic configuration, pre-configuration, or both) one or more conditions associated with performing an LTM cell switch. For example, an execution condition may be associated with a beam of a candidate cell (e.g., a neighbor cell) becoming an amount of offset better than a beam of a serving cell (which is sometimes referred to as an LTM3 condition and/or an event LTM3) and/or a beam of a serving cell becoming less than a first absolute threshold and a beam of a candidate cell becoming greater than a second absolute threshold (which is sometimes referred to as an LTM5 condition and/or an event LTM5), among other examples. When the UE detects that at least one condition (e.g., an LTM3 condition and/or an LTM5 condition, among other examples) is satisfied, the UE may perform an LTM cell switch.

For certain LTM procedures, a UE may perform transmission configuration indicator (TCI) state pre-activation for one or more candidate cells before an LTM cell switch, such as for a purpose of reducing interruption time and/or reducing latency associated with a cell switch by enabling the UE to perform reference signal monitoring and/or measurement a priori. In such aspects, the TCI state pre-activation may be triggered by a network node transmitting, to the UE, a candidate cell TCI state activation/deactivation medium access control (MAC) control element (MAC-CE). The network node may subsequently trigger an LTM cell switch (e.g., to one cell and/or TCI state indicated by the candidate cell TCI state activation/deactivation MAC-CE), such as by transmitting, to the UE, an LTM cell switch command MAC-CE. However, for the C-LTM procedure described above, in which the UE detects that LTM execution is to take place (e.g., in which the UE detects that one or more execution conditions are satisfied), the UE may be in a better position to determine a best TCI state to be used for the C-LTM procedure and/or one or more TCI states to pre-activate prior to an LTM cell switch. Accordingly, relying on the network node to pre-activate TCI states may result in inefficient usage of network resources, delayed C-LTM cell switch procedures, and/or high consumption of power, computing, and network resources associated with C-LTM procedures.

Various aspects relate generally to enhanced TCI state pre-activation for C-LTM procedures. Some aspects more specifically relate to TCI state identifier (ID) signaling for C-LTM procedures. In some aspects, a UE may identify one or more TCI states associated with a C-LTM procedure that are to be activated or deactivated. Accordingly, the UE may transmit, to a network node, a TCI state activation/deactivation request message or a TCI state activation/deactivation notification message. The UE may further activate or deactivate at least one TCI state associated with the C-LTM procedure based at least in part on the TCI state activation/deactivation request message and/or the TCI state activation/deactivation notification message. For example, in aspects in which the UE transmits the TCI state activation/deactivation request message, the UE may receive, from the network node, a TCI state activation/deactivation MAC-CE in response to the request message that indicates at least one TCI state to be activated or deactivated, and the UE may thus activate or deactivate at least one TCI state in response to receiving the TCI state activation/deactivation MAC-CE. Additionally, or alternatively, in aspects in which the UE transmits the TCI state activation/deactivation notification message, the UE may autonomously activate or deactivate at least one TCI state, and then may transmit the TCI state activation/deactivation message to inform the network node that the at least one TCI state has been activated or deactivated.

Particular aspects of the subject matter described in this disclosure can be implemented to realize one or more of the following potential advantages. In some examples, the described techniques can be used to improve transparency between the UE and the network node in connection with a C-LTM procedure, thereby reducing communication errors between network entities and thus reducing power, computing, and network resource consumption otherwise required for correcting communication errors. In some other examples, the described techniques can be used to enable a UE to select TCI states for activation or deactivation in connection with a C-LTM procedure. In this way, because the UE may be in the best position to identify TCI states to be activated and/or deactivated, as the entity monitoring signal strengths and/or identifying when cell switch execution conditions have occurred, the described techniques may result in improved C-LTM cell switch operations, resulting in reduced latency and thus more efficient usage of network resources as well as more efficient use of UE resources used to store TCI configurations.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

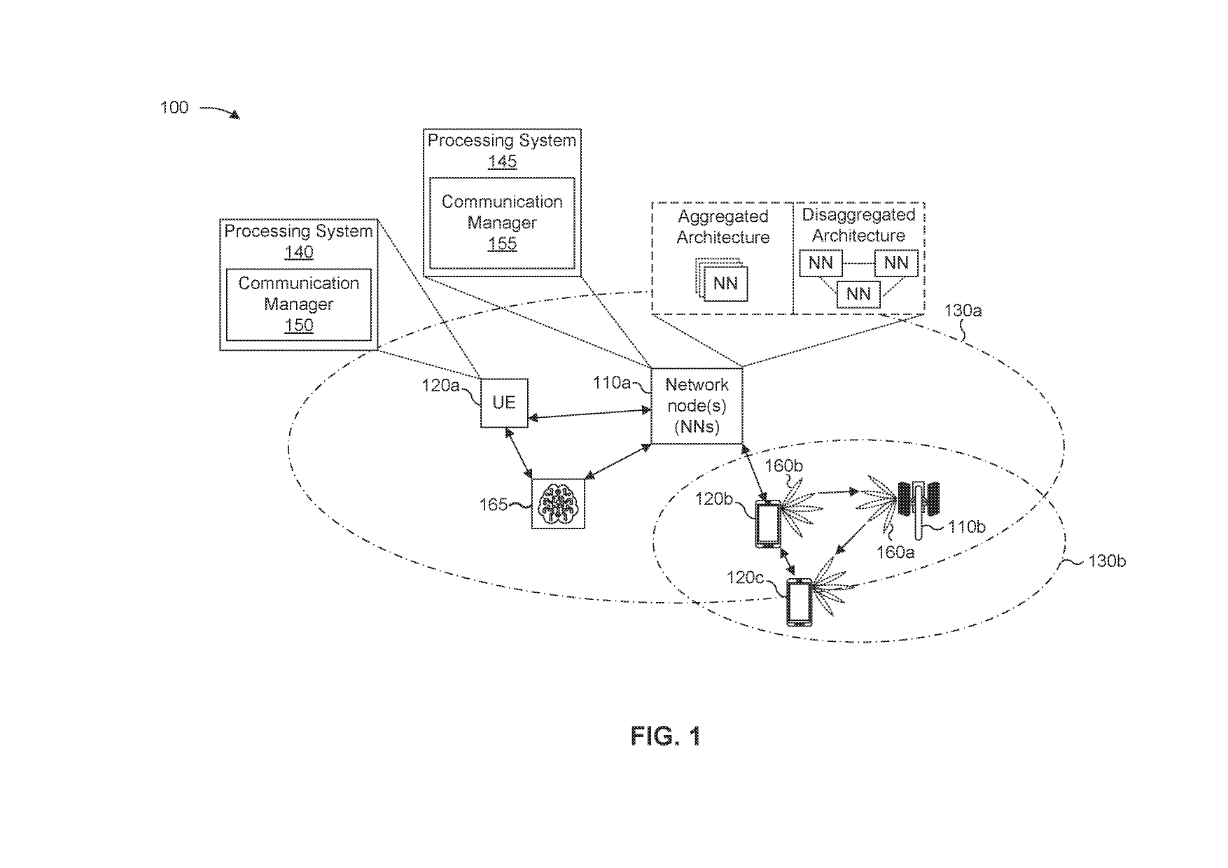

FIG. 1 is a diagram illustrating an example of a wireless communication network 100, in accordance with the present disclosure. The wireless communication network 100 may be or may include elements of a5G (or NR) network or a6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

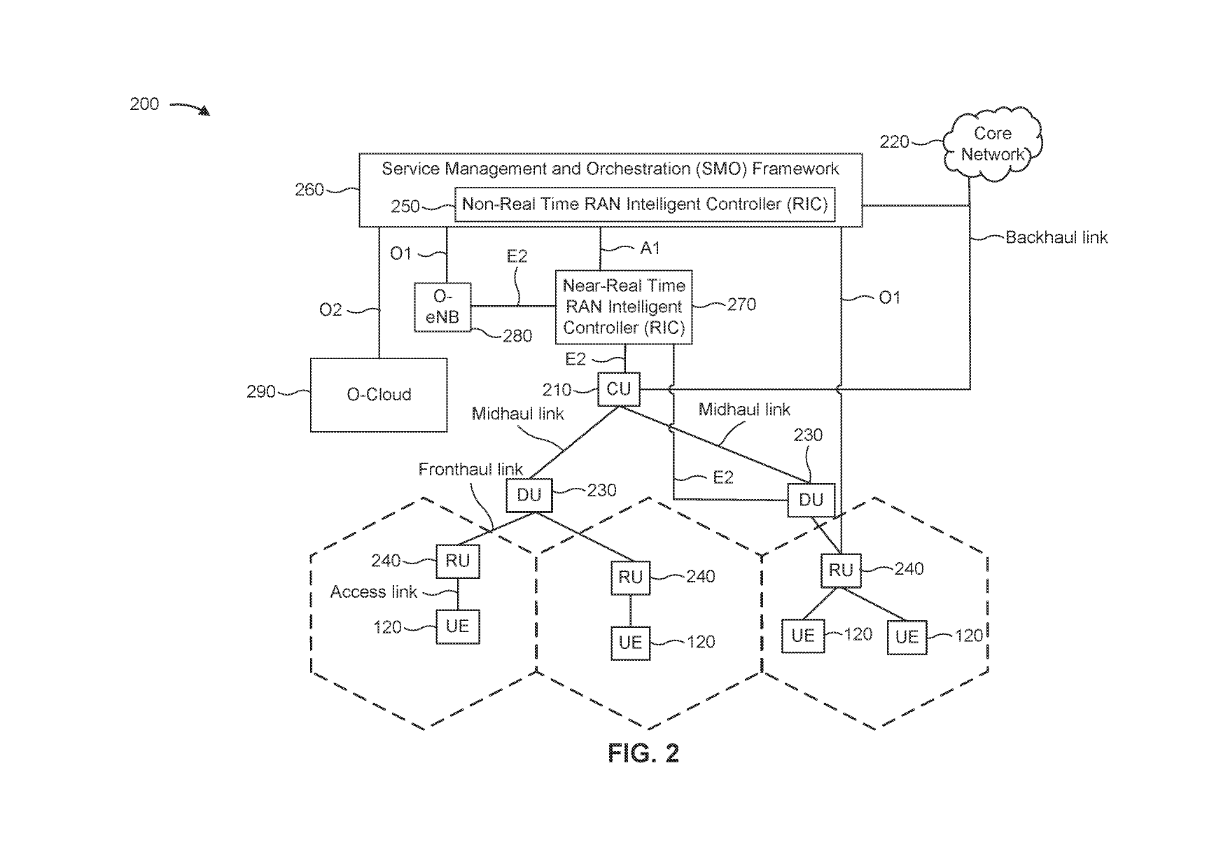

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (SS) (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

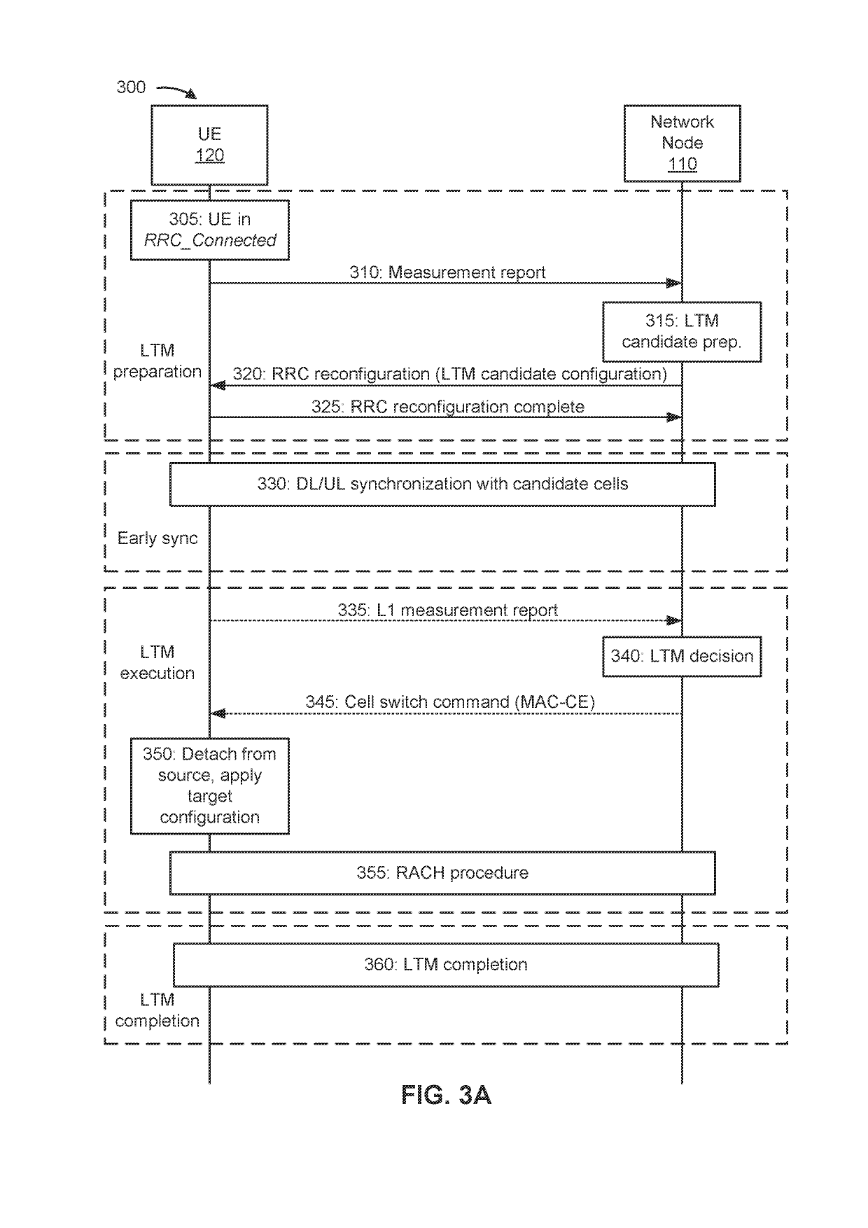

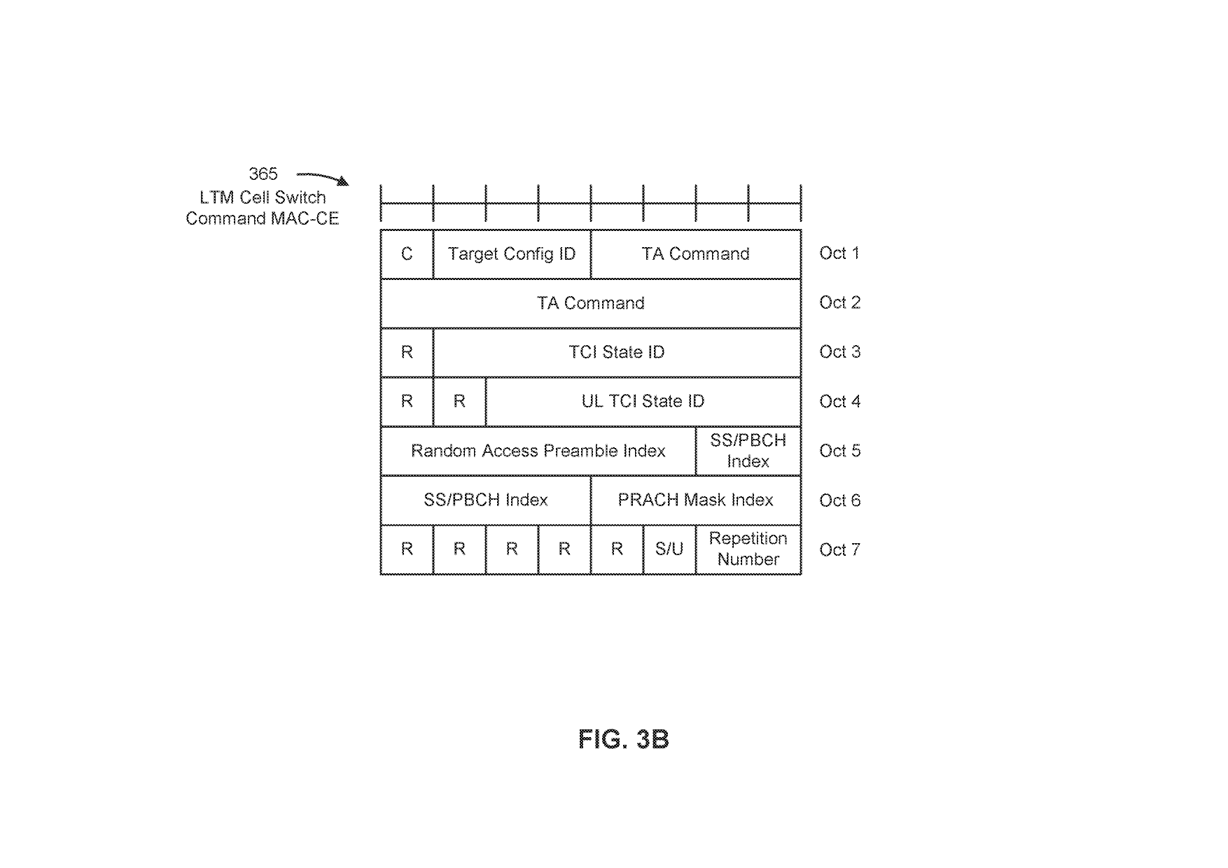

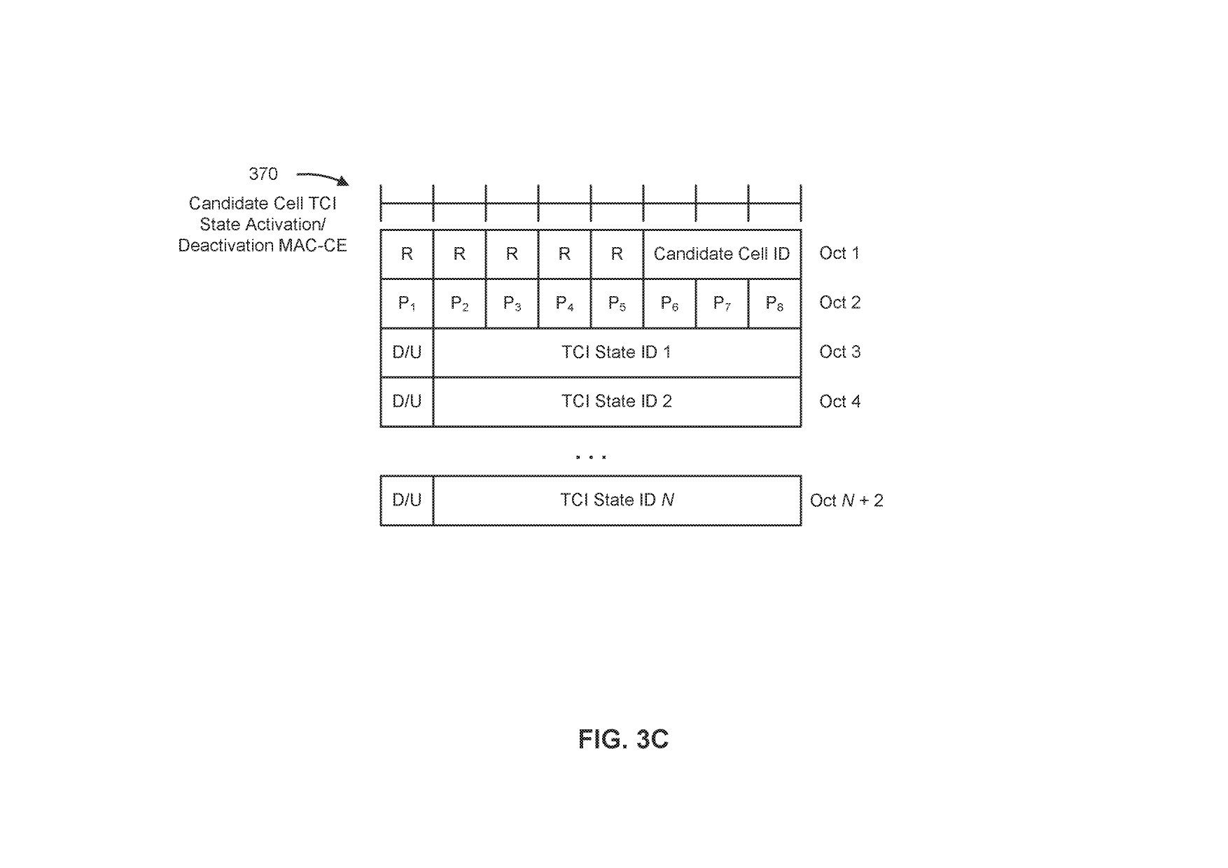

One enhancement for multi-beam operation at higher carrier frequencies is facilitation of efficient (for example, low latency and low overhead) downlink and/or uplink beam management operations to support Layer 1 and/or Layer 2 (L1/L2)-centric inter-cell mobility. L1/L2 signaling may be referred to as “lower layer” signaling. L1/L2 signaling may be used to activate and/or deactivate candidate cells in a set of cells configured for LTM and/or to provide reference signals for measurement by the UE 120, by which the UE 120 may select a candidate beam as a target beam for a lower layer handover operation. Accordingly, L1/L2-centric inter-cell mobility may enable a UE 120 to perform a cell switch via dynamic control signaling at lower layers (for example, DCI for L1 signaling or a MAC-CE for L2 signaling), rather than semi-static Layer 3 (L3) RRC signaling. Thus, L1/L2 centric inter-cell mobility may reduce latency, reduce overhead, and/or otherwise increase efficiency of the cell switch. Aspects of LTM are described in more detail below in connection with FIGS. 3A-3C.

In some aspects, the UE 120 may include a communication manager 150. As described in more detail elsewhere herein, the communication manager 150 may transmit at least one of a TCI state activation/deactivation request message or a TCI state activation/deactivation notification message; and activate or deactivate at least one TCI state associated with a C-LTM procedure based at least in part on the at least one of the TCI state activation/deactivation request message or the TCI state activation/deactivation notification message. Additionally, or alternatively, the communication manager 150 may perform one or more other operations described herein.

In some aspects, the network node 110 may include a communication manager 155. As described in more detail elsewhere herein, the communication manager 155 may receive, from a UE, at least one of a TCI state activation/deactivation request message or a TCI state activation/deactivation notification message, wherein the at least one of the TCI state activation/deactivation request message or the TCI state activation/deactivation notification message is associated with the UE activating or deactivating at least one TCI state associated with a C-LTM procedure; and transmit, in response to receiving the at least one of the TCI state activation/deactivation request message or the TCI state activation/deactivation notification message, a TCI state activation/deactivation MAC-CE associated with the UE activating or deactivating the at least one TCI state associated with the C-LTM procedure. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

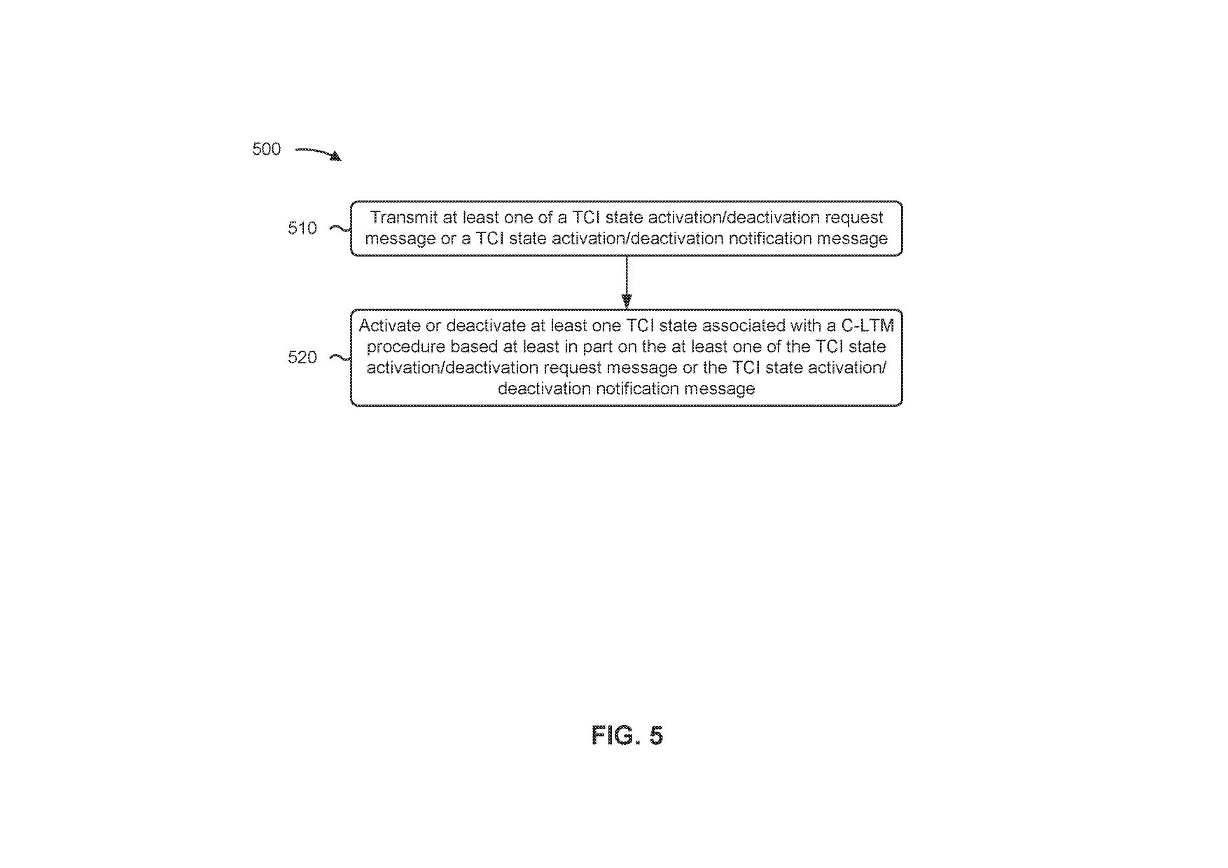

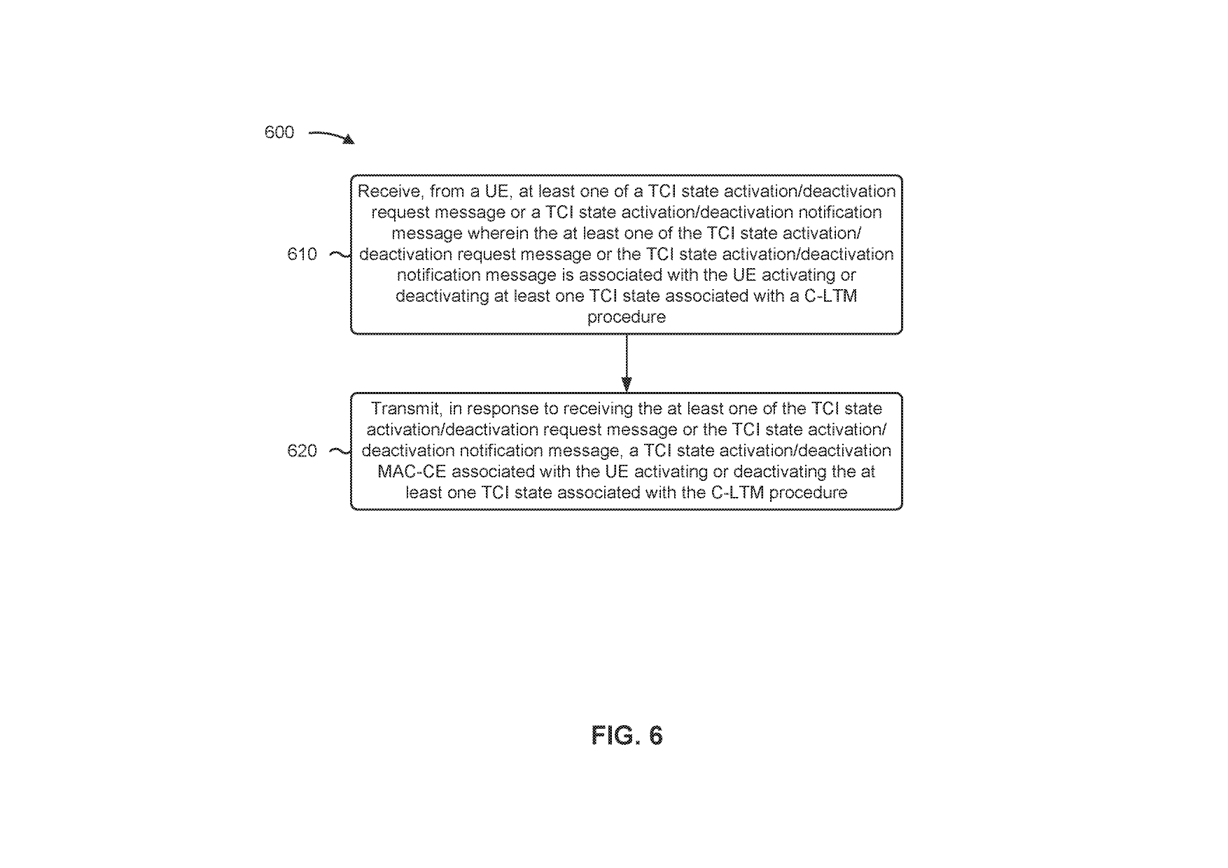

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with TCI state ID signaling for C-LTM, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, or other processes as described herein. In some examples, executing instructions may include running the instructions, converting the instructions, compiling the instructions, and/or interpreting the instructions, among other examples.

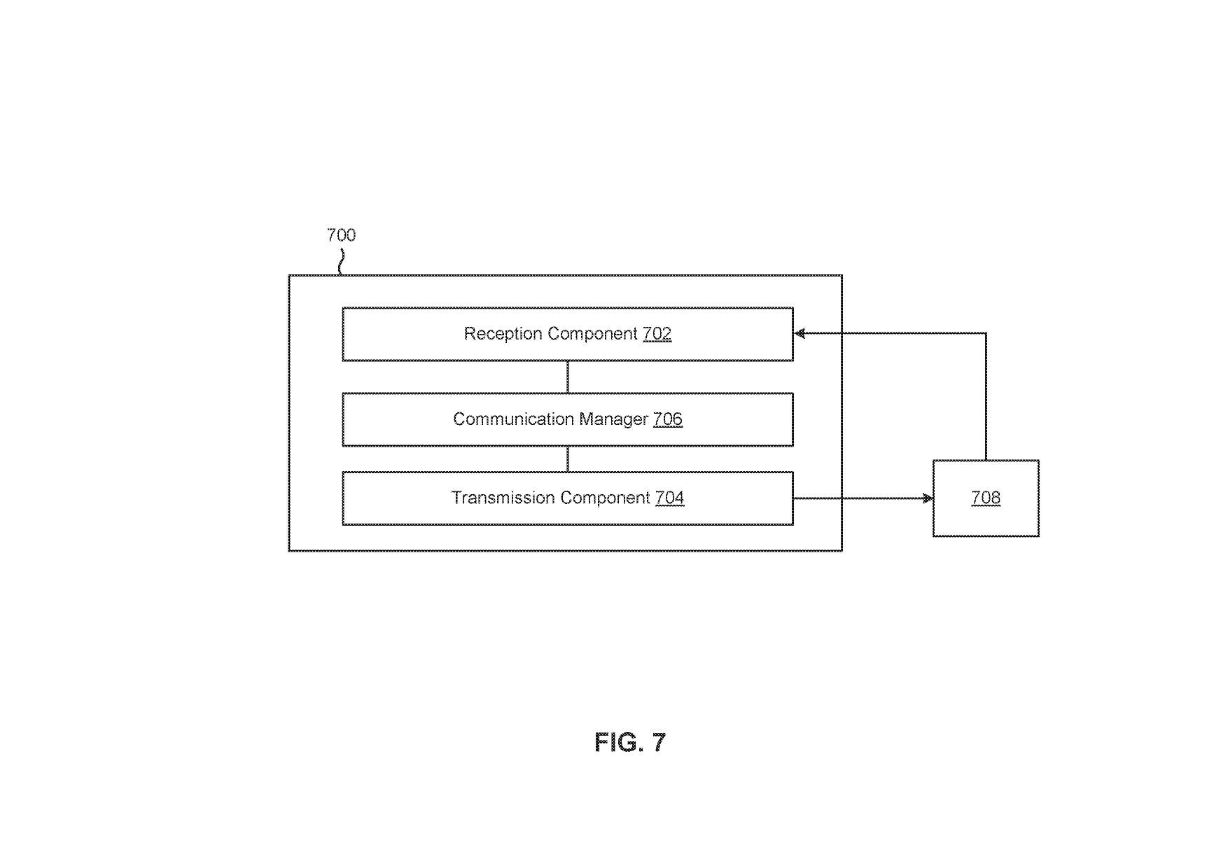

In some aspects, the UE 120 includes means for transmitting at least one of a TCI state activation/deactivation request message or a TCI state activation/deactivation notification message; and/or means for activating or deactivating at least one TCI state associated with a C-LTM procedure based at least in part on the at least one of the TCI state activation/deactivation request message or the TCI state activation/deactivation notification message. The means for the UE 120 to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), and/or a transmission component (for example, transmission component 704 depicted and described in connection with FIG. 7), among other examples.

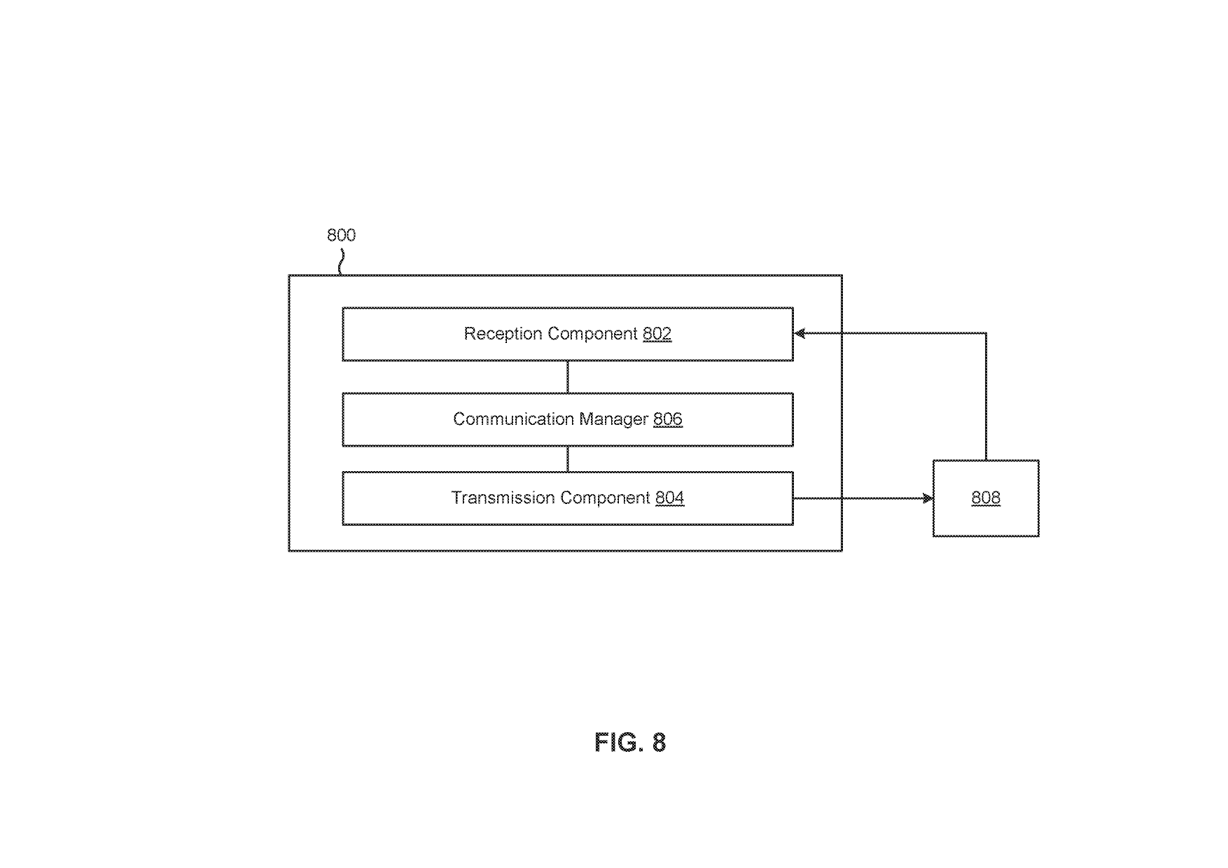

In some aspects, the network node 110 includes means for receiving, from a UE, at least one of a TCI state activation/deactivation request message or a TCI state activation/deactivation notification message, wherein the at least one of the TCI state activation/deactivation request message or the TCI state activation/deactivation notification message is associated with the UE activating or deactivating at least one TCI state associated with a C-LTM procedure; and/or means for transmitting, in response to receiving the at least one of the TCI state activation/deactivation request message or the TCI state activation/deactivation notification message, a TCI state activation/deactivation MAC-CE associated with the UE activating or deactivating the at least one TCI state associated with the C-LTM procedure. The means for the network node 110 to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

FIGS. 3A-3C are diagrams illustrating examples associated with LTM procedures, in accordance with the present disclosure.

In some examples, a network node 110 may instruct a UE 120 to change serving cells, such as when the UE 120 moves away from coverage of a current serving cell (sometimes referred to as a source cell) and towards coverage of a neighboring cell (sometimes referred to as a target cell). In some cases, the network node 110 may instruct the UE 120 to change cells using an L3 handover procedure. An L3 handover procedure may include the network node 110 transmitting, to the UE 120, an RRC reconfiguration message indicating that the UE 120 should perform a handover procedure to a target cell, which may be transmitted in response to the UE 120 providing the network node 110 with an L3 measurement report indicating signal strength measurements associated with various cells (e.g., measurements associated with the source cell and one or more neighboring cells). In response to receiving the RRC reconfiguration message, the UE 120 may communicate with the source cell and the target cell to detach from the source cell and connect to the target cell (e.g., the UE 120 may establish an RRC connection with the target cell). Once handover is complete, the target cell may communicate with a user plane function (UPF) of a core network to instruct the UPF to switch a user plane path of the UE 120 from the source cell to the target cell. The target cell may also communicate with the source cell to indicate that handover is complete and that the source cell may be released.

L3 handover procedures may be associated with high latency and high overhead due to the multiple RRC reconfiguration messages and/or other L3 signaling and operations used to perform the handover procedures. Accordingly, in some examples, a UE 120 may be configured to perform a lower-layer (e.g., L1 and/or L2) handover procedure, sometimes referred to an LTM procedure, such as example 300 LTM procedure shown in FIG. 3A. As shown in FIG. 3A, the LTM procedure may include four phases: an LTM preparation phase, an early synchronization phase (shown as “early sync” in FIG. 3A), an LTM execution phase, and/or an LTM completion phase.

During the LTM preparation phase, and as shown by reference number 305, the UE 120 may be in an RRC connected state (sometimes referred to as RRC_Connected) with a source cell. As shown by reference number 310, the UE 120 may transmit, and the network node 110 may receive, a measurement report (sometimes referred to as a MeasurementReport), which may be an L3 measurement report. The measurement report may indicate signal strength measurements (e.g., RSRP, RSSI, RSRQ, and/or CQI) or similar measurements associated with the source cell and/or one or more neighboring cells. In some examples, based at least in part on the measurement report or other information, the network node 110 may decide to use LTM, and thus, as shown by reference number 315, the network node 110 may initiate LTM candidate preparation.

As shown by reference number 320, the network node 110 may transmit, and the UE 120 may receive, an RRC reconfiguration message (sometimes referred to as an RRCReconfiguration message), which may include an LTM candidate configuration. More particularly, the RRC reconfiguration message may indicate a configuration of one or more LTM candidate target cells, which may be candidate cells to become a serving cell of the UE and/or cells for which the UE 120 may later be triggered to perform an LTM procedure. As shown by reference number 325, the UE 120 may store the configuration of the one or more LTM candidate cell configurations and, in response, may transmit, to the network node 110, an RRC reconfiguration complete message (sometimes referred to as an RRCReconfigurationComplete message).

During the early synchronization phase, and as shown by reference number 330, the UE 120 may optionally perform downlink/uplink synchronization with the candidate cells associated with the one or more LTM candidate cell configurations. For example, the UE 120 may perform downlink synchronization and timing advance (TA) acquisition with the one or more candidate target cells prior to receiving an LTM switch command (which is described in more detail below in connection with reference number 335). In some aspects, performing the early synchronization with the one or more candidate cells may reduce latency associated with performing a RACH procedure later in the LTM procedure, which is described in more detail below in connection with reference number 355.

During the LTM execution phase, and as shown by reference number 335, the UE 120 may perform L1 measurements on the configured LTM candidate target cells, and thus may transmit, to the network node 110, lower-layer (e.g., L1) measurement reports. As shown by reference number 340, based at least in part on the lower-layer measurement reports, the network node 110 may decide to execute an LTM cell switch to a target cell. Accordingly, as shown by reference number 345, the network node 110 may transmit, and the UE 120 may receive, a MAC-CE or similar message triggering an LTM cell switch (the MAC-CE or similar message is sometimes referred to herein as a cell switch command, an LTM cell switch command, and/or an LTM cell switch command MAC-CE). The cell switch command may include an indication of a candidate configuration index associated with the target cell. Additional aspects of the LTM cell switch command are described in more detail below in connection with FIG. 3B. As shown by reference number 350, based at least in part on receiving the cell switch command, the UE 120 may switch to the configuration of the LTM candidate target cell (e.g., the UE 120 may detach from the source cell and apply the target cell configuration). Moreover, as shown by reference number 355, the UE 120 may perform a RACH procedure towards the target cell, such as when a TA associated with the target cell is not available (e.g., in examples in which the UE 120 did not perform the early synchronization as described above in connection with reference number 330).

During the LTM completion phase, and as shown by reference number 360, the UE 120 may indicate successful completion of the LTM cell switch towards the target cell. In this way, cell switch to a target cell may be performed using less overhead than for an L3 handover procedure and/or a cell switch to a target cell may be associated with reduced latency as compared to L3 handover procedure.

As shown in FIG. 3B, the LTM cell switch command described above in connection with reference number 345 may be an LTM cell switch command MAC-CE 365 that triggers an LTM cell switch (as described above in connection with reference number 345). In some aspects, the LTM cell switch command MAC-CE 365 may be associated with multiple (e.g., seven) octets, shown as “Oct” in FIG. 3B.

In such examples, a first octet (e.g., “Oct 1”) includes a one-bit “C” field, which indicates a presence of contention-free random access resources fields (e.g., if the value is set to “1,” a “random access preamble index” field, an “S/U” field, an “SS/PBCH index” field, a “PRACH mask index” field, a “repetition number” field, and/or reserved bits in the same octet are present (e.g., in octets five through seven); and if the value is to “0,” the contention-free random access resources fields are absent). The first octet further includes a three-bit “target configuration ID” field, which indicates the index of candidate target configuration to apply for LTM cell switch (e.g., the ID associated with the candidate cell). The first octet and the second octet (e.g., “Oct 2”) includes a twelve-bit “TA command” field, which indicates whether the TA is valid for the LTM target cell (e.g., the cell indicated by the target configuration ID field). If the value of the TA command field is set to “FFF” (e.g., all ones) the field indicates that no valid timing adjustment is available for the primary TA group (PTAG) of the LTM target cell. Otherwise, the TA command field indicates the index value of the TA used to control the amount of timing adjustment to be applied, and that the UE 120 can skip the random access procedure for this LTM cell switch.

The third octet (e.g., “Oct 3”), in addition to one reserved bit (“R”), may include a seven bit “TCI state ID” field, which indicates and activates the TCI state for the LTM target cell (e.g., the cell indicated by the target configuration ID field). The fourth octet (e.g., “Oct 4”), in addition to two reserved bits, includes a six-bit “UL TCI state ID” field, which indicates and activates the uplink TCI state for the LTM target cell (e.g., the cell indicated by the target configuration ID field). The fifth octet (e.g., “Oct 5”) includes the six-bit random access preamble index field (when present), which indicates the random access preamble index of the contention-free random access resources. The fifth and sixth octet (e.g., “Oct 6”) includes the six-bit SS/PBCH index field (when present), which indicates the SS/PBCH that shall be used to determine the RACH occasion for the PRACH transmission of the contention-free random access resources.

The sixth octet further includes the four-bit PRACH mask index field (when present), which indicates the RACH occasion(s) associated with the SS/PBCH indicated by the SS/PBCH index field for the PRACH transmission of the contention-free random access resources. The seventh octet (e.g., “Oct 7”), in addition to five reserved bits, includes the one-bit S/U field, which indicates which UL carrier to be used to transmit the PRACH of the contention-free random access resources (e.g., if the value of this field is set to “1,” SUL is used; otherwise, NUL is used). The seventh octet also includes the two-bit repetition number field, which indicates the message 1 (Msg1) repetition number to be applied to the contention-free random access (e.g., if this field is set to “0,” Msg1 repetition number does not apply; if this field is set to “1,” the Msg1 repetition number is 2; if this field is set to “2,” the Msg1 repetition number is 4; and if this field is set to “3,” the Msg1 repetition number is 8).

As shown in FIG. 3C, a candidate cell TCI state activation/deactivation MAC-CE 370 may be transmitted from the network node 110 to the UE 120, such as for a purpose of performing early synchronization with a candidate cell (as described above in connection with reference number 330). In some aspects, the candidate cell TCI state activation/deactivation MAC-CE 370 may be used to activate/deactivate N TCI states associated with the candidate cell. In such aspects, the candidate cell TCI state activation/deactivation MAC-CE 370 may be associated with N + 2 octets.

In such examples, a first octet (e.g., “Oct 1”) includes, in addition to five reserved bits (e.g., “R”), a three-bit “candidate sell ID” field, which indicates the identity of an LTM candidate cell for which the candidate cell TCI state activation/deactivation MAC-CE 370 applies. The second octet (e.g., “Oct 2”) includes multiple (e.g., eight) one-bit “Pi” fields (e.g., the second octet includes fields “P₁” through “P₈”). The Pi fields indicate whether each TCI codepoint has multiple TCI states or a single TCI state. If the Pi field is set to 1, the i th TCI codepoint includes the DL TCI state and the UL TCI state. If the Pi field is set to 0, the i th TCI codepoint includes only the DL/joint TCI state or the UL TCI state. The codepoint to which a TCI state is mapped is determined by its ordinal position among all of the TCI state ID fields (described in more detail below).

The third through N + 2 octets (e.g., “Oct 3” through “Oct N + 2”) include a one-bit “D/U” field and a seven-bit “TCI state ID” field. The D/U field indicates whether the TCI state ID in the same octet is for a joint/downlink or an uplink TCI state. If this field is set to 1, the TCI state ID in the same octet is for a joint/downlink TCI state. If this field is set to 0, the TCI state ID in the same octet is for an uplink TCI state. The TCI state ID field indicates a corresponding TCI state. If D/U is set to 1, a 7-bit length TCI state ID is used. If D/U is set to 0, a most significant bit of a TCI state ID is considered as the reserved bit and the remaining 6 bits indicate the TCI state ID. In some examples, a maximum number of activated TCI states is 16.

In some examples, the UE 120 may be configured to trigger a switch to an LTM candidate target cell, such as in response to detecting that a certain condition has been met. Put another way, in some examples the UE 120 may perform a C-LTM cell switch associated with a C-LTM procedure. In a C-LTM procedure, the UE 120 may identify (e.g., via dynamic configuration, pre-configuration, or both) one or more conditions associated with performing an LTM cell switch. Thus, the UE 120 may identify when at least one condition of the one or more conditions is satisfied and/or may perform the C-LTM cell switch based on satisfaction of the at least one condition.

In some examples, in order to enable C-LTM, the network node 110 may transmit, to the UE 120, a C-LTM configuration (e.g., via an RRCReconfiguration message), which may indicate LTM candidate configurations and corresponding execution conditions. In some examples, an execution condition may be associated with a beam of a candidate cell (e.g., a neighbor cell) becoming an amount of offset better than a beam of a serving cell (e.g., an LTM3 condition and/or an event LTM3) and/or a beam of a serving cell becoming less than a first absolute threshold and a beam of a candidate cell becoming greater than a second absolute threshold (e.g., an LTM5 condition and/or an event LTM5). Moreover, in some aspects, each cell (e.g., a DU of the source cell and/or a DU of each candidate cell) may generate respective execution conditions for C-LTM and/or each cell may provide the respective execution conditions for C-LTM. In some aspects, C-LTM may be associated with RACH-less conditional intra-CU LTM and/or RACH-based conditional intra-CU LTM. Additionally, or alternatively, C-LTM may be associated with a UE-based TA measurement mechanism (e.g., for conditional intra-CU LTM) and/or a PDCCH-ordered early TA acquisition procedure. Moreover, C-LTM may be associated with early candidate TCI state activation and/or deactivation. Some C-LTM procedures, such as RACH-less C-LTM procedures, may be associated with a configured grant (CG) based first UL transmission. Moreover, a C-LTM procedure may be associated with an LTM completion phase that is substantially similar to the LTM competition phase described above in connection with reference number 360.

As described above in connection with FIGS. 3A-3C, for certain LTM procedures, TCI state pre-activation for one or more candidate cells, before an LTM cell switch, may reduce interruption time by enabling the UE 120 to perform reference signal monitoring and/or measurement a priori. For example, the TCI state pre-activation may be triggered by the network node 110 using the candidate cell TCI state activation/deactivation MAC-CE 370, for which a decision may be made based on L1 and/or L3 measurement reports. Moreover, the network node 110 may subsequently trigger the LTM cell switch command, such as by transmitting the LTM cell switch command MAC-CE 365.

However, for the C-LTM procedure described above, in which the UE 120 detects that LTM execution is to take place (e.g., in which the UE 120 detects that one or more execution conditions are satisfied), the UE 120 will determine that LTM execution is to occur without receiving the LTM cell switch command MAC-CE 365. In such cases, the UE 120 may be in a better position to determine a best TCI state to be used for the C-LTM procedure and/or the best TCI state(s) to be pre-activated in anticipation of a C-LTM cell switch.

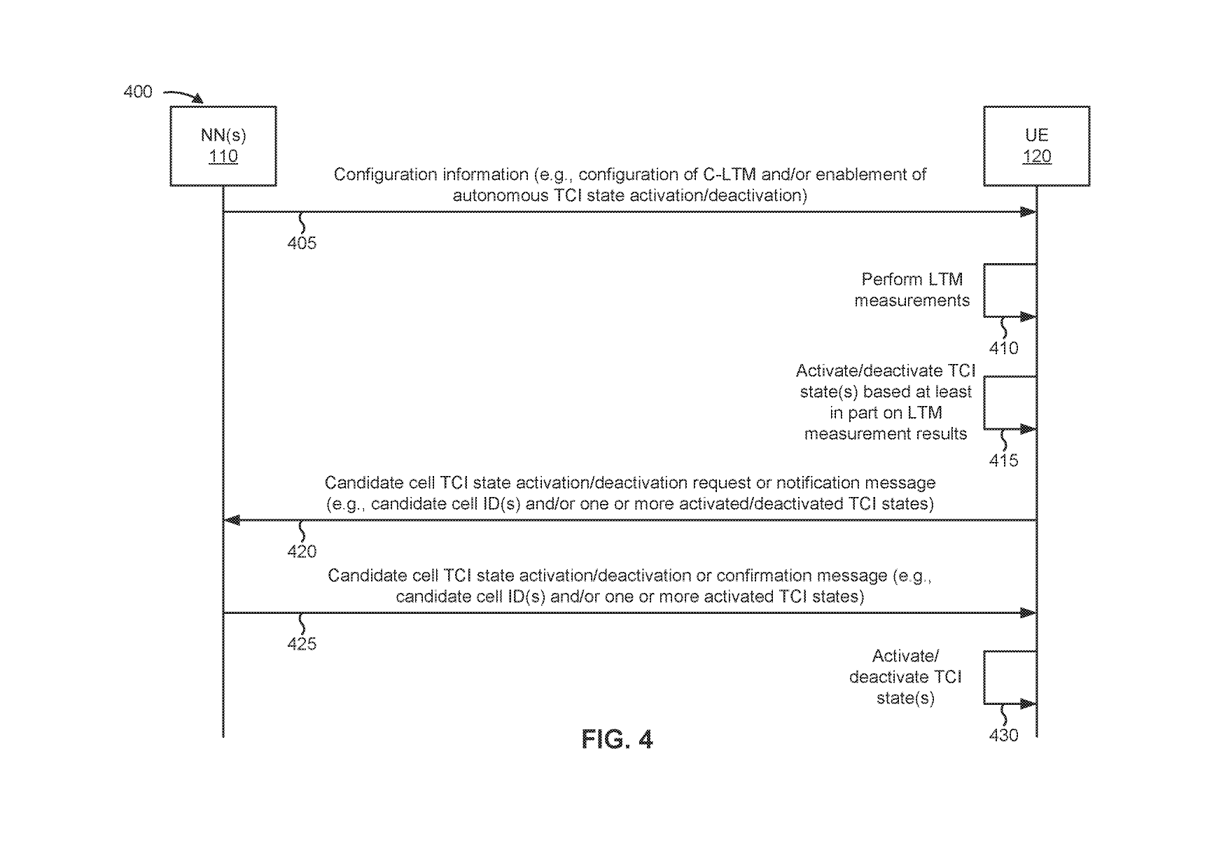

Some aspects described herein enable signaling between the UE 120 and a network node 110 to support TCI state pre-activation by the UE 120 during a C-LTM procedure, thereby reducing latency associated with a C-LTM procedure and/or reducing communication errors following a C-LTM cell switch. In some aspects, signaling between the UE 120 and the network node 110 may enable the UE 120 to be actively involved in TCI state activation prior to execution of a C-LTM cell switch. This may become more readily understood with reference to FIG. 4.

As indicated above, FIGS. 3A-3C are provided as examples. Other examples may differ from what is described with respect to FIGS. 3A-3C.

FIG. 4 is a diagram of an example 400 associated with TCI state ID signaling for C-LTM, in accordance with the present disclosure. As shown in FIG. 4, a network node 110 (e.g., a CU, a DU, and/or an RU) may communicate with a UE 120. In some aspects, the network node 110 and the UE 120 may be part of a wireless network (e.g., wireless communication network 100). The UE 120 and the network node 110 may have established a wireless connection prior to operations shown in FIG. 4. In some aspects, the network node 110 and/or the UE 120 may be associated with a C-LTM procedure.

As shown by reference number 405, the network node 110 may transmit, and the UE 120 may receive, configuration information. In some aspects, the UE 120 may receive the configuration information via one or more of system information (e.g., a master information block (MIB) and/or a system information block (SIB), among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC CEs and/or one or more DCI messages, among other examples.

In some aspects, the configuration information may configure the UE 120 to perform a C-LTM procedure. Put another way, in some aspects the configuration information may include a C-LTM configuration. In some aspects, the configuration information may be associated with an RRCReconfiguration message, among other examples. Additionally, or alternatively, the C-LTM configuration may indicate LTM candidate configurations and/or one or more execution conditions. For example, the C-LTM configuration may indicate one or more candidate cells for performing an LTM cell switch, and, for each candidate cell, one or more execution conditions for triggering the LTM cell switch. In some aspects, the one or more execution conditions may be associated with a beam of a candidate cell becoming an amount of offset better than a beam of a serving cell (e.g., an LTM3 condition and/or an event LTM3), a beam of a serving cell becoming less than a first absolute threshold and a beam of a candidate cell becoming greater than a second absolute threshold (e.g., an LTM5 condition and/or an event LTM5), and/or a similar condition.

Additionally, or alternatively, in some aspects the configuration information may enable autonomous TCI state activation and/or deactivation by the UE 120. For example, the configuration information may enable activation or deactivation of at least one TCI state without transmission of a TCI state activation/deactivation request message, and/or the configuration information may enable transmission of a TCI state activation/deactivation notification message that indicates that at least one TCI state has been autonomously activated and/or deactivated by the UE 120. Aspects of autonomous TCI state activation and/or deactivation and/or notification by the UE 120 are described in more detail below in connection with reference numbers 415 and 420.

The UE 120 may configure itself based at least in part on the configuration information. In some aspects, the UE 120 may be configured to perform one or more operations described herein based at least in part on the configuration information.

In some aspects, the UE 120 may transmit, and the network node 110 may receive, capability information (e.g., a capabilities report) (not shown). The capability information may indicate whether the UE 120 supports a feature and/or one or more parameters related to the feature. For example, the capability information may indicate a capability and/or parameter for supporting LTM cell switching. As another example, the capability information may indicate a capability and/or parameter for supporting C-LTM cell switching. One or more operations described herein may be based on the capability information. For example, the UE 120 may perform a communication in accordance with the capability information, or may receive configuration information that is in accordance with the capability information. In some aspects, the capability information may indicate UE 120 support for pre-activating one or more TCI states associated with a C-LTM cell switch procedure

In some aspects, the configuration information described in connection with reference number 405 and/or the capability information may include information transmitted via multiple communications. Additionally, or alternatively, the network node 110 may transmit the configuration information, or a communication including at least a portion of the configuration information, before and/or after the UE 120 transmits the capability information. For example, the network node 110 may transmit a first portion of the configuration information before the capability information, the UE 120 may transmit at least a portion of the capability information, and the network node 110 may transmit a second portion of the configuration information after receiving the capability information.

As shown by reference number 410, the UE 120 may perform one or more LTM measurements associated with one or more candidate cells. For example, the UE 120 may perform signal strength measurements (e.g., RSRP, RSSI, RSRQ, and/or CQI) or similar measurements associated with a source cell (e.g., a current serving cell) and/or one or more candidate cells (e.g., one or more cells indicated by the C-LTM configuration, such as via the configuration information described above in connection with reference number 405).

In some aspects, based at least in part on the LTM measurement results, among other information, the UE 120 may determine that one or more TCI states associated with one or more candidate cells are to be activated (e.g., the UE 120 may decide to prepare or switch to a specific TCI state, such as by shifting communication parameters, such as beamforming settings, to align with the configuration defined for the one or more TCI states). Additionally, or alternatively, based at least in part on the LTM measurement results, among other information, the UE 120 may determine that one or more TCI states associated with one or more candidate cells are to be deactivated. For example, based at least in part on LTM measurement results associated with a certain cell nearing an execution condition, the UE 120 may determine that one or more TCI states associated with that cell should be activated, such as for a purpose of reducing latency associated with a C-LTM cell switch once the LTM measurement results satisfy the execution condition. On the other hand, based at least in part on LTM measurement results associated with a certain cell moving away from an execution condition, the UE 120 may determine that one or more TCI states associated with that cell should be deactivated, such as for a purpose of freeing up resources otherwise used to maintain an activated TCI state for a candidate cell for which a C-LTM cell switch is becoming unlikely.

In some aspects, the UE 120 may be configured (e.g., via the configuration information described above in connection with reference number 405), preconfigured (e.g., hard-coded per a wireless communication standard, such as a wireless communication standard promulgated by the 3GPP, among other examples), or otherwise enabled to perform autonomous TCI state activation and/or deactivation. Put another way, in some aspects the UE 120 may be capable of activating one or more TCI states associated with a C-LTM procedure or deactivating one or more TCI states associated with a C-LTM procedure without further instruction from the network node 110 or other network entity. In such aspects, and as indicated by reference number 415, based at least in part on the LTM measurement results, among other information, the UE 120 may autonomously activate and/or deactivate one or more TCI states associated with one or more candidate cells of a C-LTM procedure.

As indicated by reference number 420, the UE 120 may transmit, and the network node 110 may receive, a TCI state activation/deactivation request message or a TCI state activation/deactivation notification message. More particularly, as described above in connection with reference number 415, in some aspects the UE 120 may be capable of autonomously activating and/or deactivating one or more TCI states. In such aspects, the communication shown in connection with reference number 420 may be the TCI state activation/deactivation notification message, which may be used to notify the network node 110 that the one or more TCI states have been autonomously activated or deactivated by the UE 120. In some other aspects, the UE 120 may not be configured, preconfigured, or otherwise enabled to autonomously activate and/or deactivate one or more TCI states, but nonetheless may be configured, preconfigured, and/or enabled to identify one or more TCI states to be activated and/or deactivated and/or to recommend, to the network node 110, that the one or more TCI states should be activated and/or deactivated. In such aspects, the UE 120 may, prior to activating or deactivating any TCI states, send a request to the network node 110 to activate or deactivate the one or more TCI states. In such aspects, the communication shown in connection with reference number 420 may be the TCI state activation/deactivation request message.

In aspects in which the communication shown in connection with reference number 420 is the TCI state activation/deactivation request message, the TCI state activation/deactivation request message may be a MAC-CE used to indicate the one or more TCI states to be activated or deactivated. For example, the TCI state activation/deactivation request message may be a MAC-CE that indicates a candidate cell ID corresponding to a cell for which one or more TCI states are to be activated and/or deactivated, one or more TCI states associated with the candidate cell ID, one or more joint/separate TCI state indicators associated with the one or more TCI states, one or more downlink/joint TCI state or uplink TCI state indicators associated with the one or more TCI states, and/or one or more activation/deactivation indicators associated with the one or more TCI states. In that regard, the TCI state activation/deactivation request message may include similar information as the candidate cell TCI state activation/deactivation MAC-CE 370 described above in connection with FIG. 3C.

More particularly, the TCI state activation/deactivation request message may include a candidate cell ID field, which may indicate the identity of an LTM candidate cell for which the TCI state activation/deactivation request message applies. The TCI state activation/deactivation request message may further include one or more joint/separate TCI state indicator fields that indicate whether each TCI codepoint has multiple TCI states or a single TCI state (and thus which may be similar to the Pi fields described above in connection with FIG. 3C). In such aspects, if an i th joint/separate TCI state indicator field is set to 1, the i th TCI codepoint may include the DL TCI state and the UL TCI state. If the i th joint/separate TCI state indicator field is set to 0, the i th TCI codepoint may include only the DL/joint TCI state or the UL TCI state. In such aspects, the codepoint to which a TCI state is mapped may be determined by its ordinal position among all the TCI state ID fields.

The TCI state activation/deactivation request message may further include one or more TCI state ID fields and, for each TCI state ID field, a corresponding downlink/joint TCI state or uplink TCI state indicator field (which may be similar to the D/U field described above). The downlink/joint TCI state or uplink TCI state indicator field may indicate whether the corresponding TCI state is for a joint/downlink or an uplink TCI state. For example, if the downlink/joint TCI state or uplink TCI state indicator field is set to 1, the corresponding TCI state ID may be for a joint/downlink TCI state. If the downlink/joint TCI state or uplink TCI state indicator field is set to 0, the corresponding TCI state ID may be for an uplink TCI state. Moreover, the TCI state activation/deactivation request message may further include, for each TCI state ID field, a corresponding activation/deactivation indicator field. The activation/deactivation indicator field may indicate whether the UE is requesting the corresponding TCI state to be activated or deactivated. For example, if the activation/deactivation field is set to one of 1 or 0, the UE may be requesting that the corresponding TCI state ID be activated. If the activation/deactivation field is set to the other one of 1 or 0, the UE may be requesting that the corresponding TCI state ID be deactivated.

In some aspects, the TCI state activation/deactivation request message may be used by the UE 120 to indicate only downlink TCI states and/or only uplink TCI states. For example, the TCI state activation/deactivation request message may be restricted (e.g., via the configuration information described above in connection with reference number 405 and/or via a relevant wireless communication standard, among other examples) to requesting and/or recommending only DL/joint TCI states to be activated and/or deactivated. In such examples, certain fields described above may be omitted from the TCI state activation/deactivation request message. More particularly, when the TCI state activation/deactivation request message is restricted to requesting and/or recommending only DL/joint TCI states, the one or more joint/separate TCI state indicators and/or the one or more downlink/joint TCI state or uplink TCI state indicators may be omitted from the TCI state activation/deactivation request message.

In aspects in which the communication shown in connection with reference number 420 is the TCI state activation/deactivation notification message, the TCI state activation/deactivation notification message may be a MAC-CE used to indicate the one or more TCI states that have been autonomously activated or deactivated (e.g., via the operations described above in connection with reference number 415). For example, the TCI state activation/deactivation notification message may be a MAC-CE that indicates one or more candidate cell IDs corresponding to one or more cells for which one or more TCI states were autonomously activated and/or deactivated, one or more TCI states associated with each of the one or more candidate cell IDs, and/or one or more activation/deactivation indicators associated with the one or more TCI states associated with each of the one or more candidate cell IDs.

More particularly, the TCI state activation/deactivation notification message may include one or more candidate cell ID fields, which may indicate the identity of one or more LTM candidate cells for which the UE has autonomously activated and/or deactivated TCI states (e.g., via the operations described above in connection with reference number 415). The TCI state activation/deactivation notification message may further include one or more TCI state ID fields corresponding to each candidate cell ID field (e.g., multiple TCI state IDs may be present, such as in aspects in which the UE 120 is capable of activating multiple TCI states). In such aspects, the network node 110 may determine whether an UL TCI state ID is present for a given candidate cell based on the C-LTM configuration information for that candidate cell (e.g., based on a target configuration ID), such as based on the unifiedTCI-StateType in the ltmTCI-Info for that candidate cell. In such aspects, if the unifiedTCI-StateType in the ltmTCI-Info for that candidate cell is set to “joint,” the UL TCI state information may be absent from the TCI state activation/deactivation notification message. Moreover, the TCI state activation/deactivation notification message may further include, for each TCI state ID field, a corresponding activation/deactivation indicator field. The activation/deactivation indicator field may indicate whether the UE activated or deactivated the corresponding TCI state (e.g., via the operations described above in connection with reference number 415). For example, if the activation/deactivation field is set to one of 1 or 0, the UE may have activated the corresponding TCI state. If the activation/deactivation field is set to the other one of 1 or 0, the UE may have deactivated the corresponding TCI state.

In some aspects, the TCI state activation/deactivation notification message may be used by the UE 120 to indicate that TCI states associated with multiple candidate cells have been activated and/or deactivated, as described above. Put another way, in some aspects notification of activation and/or deactivation of TCI states for multiple candidate cells may be aggregated into a single TCI state activation/deactivation notification message (e.g., a single MAC-CE). In such aspects, the TCI state activation/deactivation notification message may indicate whether the TCI state activation/deactivation notification message includes TCI states for multiple candidate cells. For example, the TCI state activation/deactivation notification message may include an indicator that indicates whether a particular field and/or octet is an end of information associated with a current candidate cell. In such aspects, the indicator may be set to one of 1 or 0 to indicate that the TCI state activation/deactivation notification message includes additional TCI states associated with that candidate cell, and may be set to the other one of 1 or 0 to indicate that the TCI state is the last TCI state included in the TCI state activation/deactivation notification message for that particular candidate cell. Additionally, or alternatively, the TCI state activation/deactivation notification message may include a field and/or parameter used to indicate a quantity of TCI state IDs that are included for a given candidate cell ID.

In some aspects, autonomous TCI state activation and/or deactivation by the UE 120, and/or the subsequent transmission of the TCI state activation/deactivation notification message, may be enabled and/or disabled by the network node 110, such as via the configuration information described above in connection with reference number 405. For example, in some aspects a single configuration parameter may be used by the network node 110 to jointly enable or disable autonomous TCI state activation/deactivation and subsequent notification, while, in some other aspects, two different configuration parameters may be used by the network node 110 to separately enable or disable autonomous TCI state activation/deactivation and subsequent notification. Put another way, in some aspects, the network node 110 may transmit, and the UE 120 may receive, configuration information (e.g., the configuration information described above in connection with reference number 405) that enables activation or deactivation of at least one TCI state without transmission of the TCI state activation/deactivation request message and/or transmission of the TCI state activation/deactivation notification message.

Similarly, the UE 120 may report a capability (e.g., via the capability information described above) to support autonomous TCI state activation and/or deactivation by the UE 120 and/or the subsequent transmission of the TCI state activation/deactivation notification message by the UE 120. For example, in some aspects the UE 120 may report a single capability parameter to jointly indicate support for autonomous TCI state activation/deactivation and subsequent notification, while, in some other aspects, the UE 120 may report two different capability parameters to separately indicate support for autonomous TCI state activation/deactivation and subsequent notification. Put another way, in some aspects, the UE 120 may transmit, and the network node 110 may receive, capability information that indicates UE 120 support for activation or deactivation of at least one TCI state without transmission of the TCI state activation/deactivation request message and/or transmission of the TCI state activation/deactivation notification message.

As indicated by reference number 425, the network node 110 may transmit, and the UE 120 may receive, a candidate cell TCI state activation/deactivation message and/or a TCI state activation/deactivation confirmation message. For example, in aspects in which the UE 120 transmits the TCI state activation/deactivation request message, the network node 110 may transmit a message indicating which, if any, of the TCI states requested by the UE 120 are to be activated and/or are to be deactivated. Moreover, in aspects in which the UE 120 transmits the TCI state activation/deactivation notification message, the network node 110 may transmit a message indicating confirmation of the activated and/or deactivated TCI states and/or indicating whether the activated and/or deactivated TCI states are to be modified.

In some aspects, the candidate cell TCI state activation/deactivation message and/or the TCI state activation/deactivation confirmation message shown in connection with reference number 425 may be a TCI state activation/deactivation MAC-CE, such as the candidate cell TCI state activation/deactivation MAC-CE 370 described above in connection with FIG. 3C, among other examples. For example, in aspects in which the UE 120 transmits the TCI state activation/deactivation request message, the network node 110 may transmit the TCI state activation/deactivation MAC-CE to indicate which, if any, of the requested TCI states are to be activated or deactivated.

Similarly, in aspects in which the UE 120 transmits the TCI state activation/deactivation notification message, the network node 110 may transmit the TCI state activation/deactivation MAC-CE to confirm the autonomously activated and/or deactivated TCI states and/or to indicate any modifications to the autonomously activated and/or deactivated TCI states. More particularly, in aspects in which the TCI state activation/deactivation MAC-CE includes the same TCI state information as the TCI state activation/deactivation notification message, the TCI state activation/deactivation MAC-CE may serve as a confirmation to the UE 120 and thus the UE 120 may need to take no further action. Put another way, the TCI state activation/deactivation MAC-CE may confirm activation or deactivation of at least one TCI state by indicating the same TCI state information as the TCI state information indicated by the TCI state activation/deactivation notification message.

On the other hand, in aspects in which the TCI state activation/deactivation MAC-CE includes different TCI state information from the TCI state activation/deactivation notification message, then UE 120 may be expected to activate TCI states indicated by the TCI state activation/deactivation MAC-CE and/or deactivate any TCI states not indicated by the TCI state activation/deactivation MAC-CE. Put another way, if the TCI state activation/deactivation MAC-CE indicates different TCI state information than TCI state information indicated by the TCI state activation/deactivation notification message, the UE 120 may be signaled to activate one or more TCI states indicated by the TCI state activation/deactivation MAC-CE that were not indicated by the TCI state activation/deactivation notification message, and/or deactivate one or more TCI states indicated by the TCI state activation/deactivation notification message that were not indicated by the TCI state activation/deactivation MAC-CE.

As indicated by reference number 430, based at least in part on receiving a TCI state activation/deactivation message and/or a TCI state activation/deactivation confirmation message (e.g., the candidate cell TCI state activation/deactivation MAC-CE 370), the UE 120 may activate and/or deactivate one or more TCI states. For example, in aspects in which the network node 110 transmits the TCI state activation/deactivation MAC-CE in response to the TCI state activation/deactivation request message, the UE 120 may activate and/or deactivate TCI states in accordance with TCI state information included in the TCI state activation/deactivation MAC-CE. Additionally, or alternatively, in aspects in which the network node 110 transmits the TCI state activation/deactivation MAC-CE in response to the TCI state activation/deactivation notification message, the UE 120 may activate and/or deactivate TCI states in accordance with the TCI state activation/deactivation MAC-CE if the TCI state information indicated by the TCI state activation/deactivation MAC-CE differs from the TCI state information indicated by the TCI state activation/deactivation notification message. More particularly, the UE 120 may activate one or more TCI states indicated by the TCI state activation/deactivation MAC-CE that were not indicated by the TCI state activation/deactivation notification message, and/or the UE 120 may deactivate one or more TCI states indicated by the TCI state activation/deactivation notification message that were not indicated by the TCI state activation/deactivation MAC-CE.

Based at least in part on the UE 120 signaling, to the network node 110, at least one of the TCI state activation/deactivation request message or the TCI state activation/deactivation notification message in connection with a C-LTM procedure, the UE 120 and/or the network node 110 may conserve computing, power, network, and/or communication resources that may have otherwise been consumed by using traditional C-LTM procedures. For example, based at least in part on the UE 120 signaling, to the network node 110, at least one of the TCI state activation/deactivation request message or the TCI state activation/deactivation notification message in connection with a C-LTM procedure, the UE 120 may perform a C-LTM cell switch with reduced latency and/or the network node 110 and the UE 120 may communicate with a reduced error rate following the C-LTM cell switch, which may conserve computing, power, network, and/or communication resources that may have otherwise been consumed to detect and/or correct communication errors.

As indicated above, FIG. 4 is provided as an example. Other examples may differ from what is described with respect to FIG. 4.

FIG. 5 is a diagram illustrating an example process 500 performed, for example, at a UE or an apparatus of a UE, in accordance with the present disclosure. Example process 500 is an example where the apparatus or the UE (e.g., UE 120) performs operations associated with TCI state ID signaling for C-LTM.

As shown in FIG. 5, in some aspects, process 500 may include transmitting at least one of a TCI state activation/deactivation request message or a TCI state activation/deactivation notification message (block 510). For example, the UE (e.g., using transmission component 704 and/or communication manager 706, depicted in FIG. 7) may transmit at least one of a TCI state activation/deactivation request message or a TCI state activation/deactivation notification message, as described above.

As further shown in FIG. 5, in some aspects, process 500 may include activating or deactivating at least one TCI state associated with a C-LTM procedure based at least in part on the at least one of the TCI state activation/deactivation request message or the TCI state activation/deactivation notification message (block 520). For example, the UE (e.g., using communication manager 706, depicted in FIG. 7) may activate or deactivate at least one TCI state associated with a C-LTM procedure based at least in part on the at least one of the TCI state activation/deactivation request message or the TCI state activation/deactivation notification message, as described above.

Process 500 may include additional aspects, such as any single aspect or any combination of aspects described below and/or in connection with one or more other processes described elsewhere herein.

In a first aspect, transmitting that at least one of the TCI state activation/deactivation request message or the TCI state activation/deactivation notification message includes transmitting the TCI state activation/deactivation request message.

In a second aspect, alone or in combination with the first aspect, the TCI state activation/deactivation request message is associated with a MAC-CE.

In a third aspect, alone or in combination with one or more of the first and second aspects, process 500 includes receiving, in response to transmitting the TCI state activation/deactivation request message, a TCI state activation/deactivation MAC-CE indicating that one or more TCI states are to be activated or deactivated.

In a fourth aspect, alone or in combination with one or more of the first through third aspects, the TCI state activation/deactivation request message indicates at least one of a candidate cell ID, one or more TCI states associated with the candidate cell ID, one or more joint/separate TCI state indicators associated with the one or more TCI states, one or more downlink/joint TCI state or uplink TCI state indicators associated with the one or more TCI states, or one or more activation/deactivation indicators associated with the one or more TCI states.

In a fifth aspect, alone or in combination with one or more of the first through fourth aspects, transmitting the at least one of the TCI state activation/deactivation request message or the TCI state activation/deactivation notification message includes transmitting the TCI state activation/deactivation notification message.

In a sixth aspect, alone or in combination with one or more of the first through fifth aspects, the TCI state activation/deactivation notification message is associated with a MAC-CE.

In a seventh aspect, alone or in combination with one or more of the first through sixth aspects, transmitting the TCI state activation/deactivation notification message includes transmitting the TCI state activation/deactivation notification message in response to activating or deactivating the at least one TCI state.

In an eighth aspect, alone or in combination with one or more of the first through seventh aspects, the TCI state activation/deactivation notification message indicates at least one of one or more candidate cell IDs, one or more TCI states associated with each of the one or more candidate cell IDs, or one or more activation/deactivation indicators associated with the one or more TCI states associated with each of the one or more candidate cell IDs.

In a ninth aspect, alone or in combination with one or more of the first through eighth aspects, process 500 includes receiving configuration information that enables at least one of activation or deactivation of the at least one TCI state without transmission of the TCI state activation/deactivation request message, or transmission of the TCI state activation/deactivation notification message.

In a tenth aspect, alone or in combination with one or more of the first through ninth aspects, process 500 includes receiving, in response to transmitting the TCI state activation/deactivation notification message, a TCI state activation/deactivation MAC-CE.

In an eleventh aspect, alone or in combination with one or more of the first through tenth aspects, the TCI state activation/deactivation MAC-CE confirms activation or deactivation of the at least one TCI state by indicating the same TCI state information as the TCI state information indicated by the TCI state activation/deactivation notification message.

In a twelfth aspect, alone or in combination with one or more of the first through eleventh aspects, the TCI state activation/deactivation MAC-CE indicates different TCI state information than the TCI state information indicated by the TCI state activation/deactivation notification message, and the process 500 further comprises at least one of activating one or more TCI states indicated by the TCI state activation/deactivation MAC-CE that were not indicated by the TCI state activation/deactivation notification message, or deactivating one or more TCI states indicated by the TCI state activation/deactivation notification message that were not indicated by the TCI state activation/deactivation MAC-CE.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node, in accordance with the present disclosure. Example process 600 is an example where the apparatus or the network node (e.g., network node 110) performs operations associated with TCI state ID signaling for C-LTM.

As shown in FIG. 6, in some aspects, process 600 may include receiving, from a UE, at least one of a TCI state activation/deactivation request message or a TCI state activation/deactivation notification message, wherein the at least one of the TCI state activation/deactivation request message or the TCI state activation/deactivation notification message is associated with the UE activating or deactivating at least one TCI state associated with a C-LTM procedure (block 610). For example, the network node (e.g., using reception component 802 and/or communication manager 806, depicted in FIG. 8) may receive, from a UE, at least one of a TCI state activation/deactivation request message or a TCI state activation/deactivation notification message, wherein the at least one of the TCI state activation/deactivation request message or the TCI state activation/deactivation notification message is associated with the UE activating or deactivating at least one TCI state associated with a C-LTM procedure, as described above.

As further shown in FIG. 6, in some aspects, process 600 may include transmitting, in response to receiving the at least one of the TCI state activation/deactivation request message or the TCI state activation/deactivation notification message, a TCI state activation/deactivation MAC-CE associated with the UE activating or deactivating the at least one TCI state associated with the C-LTM procedure (block 620). For example, the network node (e.g., using transmission component 804 and/or communication manager 806, depicted in FIG. 8) may transmit, in response to receiving the at least one of the TCI state activation/deactivation request message or the TCI state activation/deactivation notification message, a TCI state activation/deactivation MAC-CE associated with the UE activating or deactivating the at least one TCI state associated with the C-LTM procedure, as described above.

Process 600 may include additional aspects, such as any single aspect or any combination of aspects described below and/or in connection with one or more other processes described elsewhere herein.

In a first aspect, receiving that at least one of the TCI state activation/deactivation request message or the TCI state activation/deactivation notification message includes receiving the TCI state activation/deactivation request message.

In a second aspect, alone or in combination with the first aspect, the TCI state activation/deactivation request message is associated with a MAC-CE.

In a third aspect, alone or in combination with one or more of the first and second aspects, the TCI state activation/deactivation MAC-CE indicates one or more TCI states that are to be activated or deactivated.

In a fourth aspect, alone or in combination with one or more of the first through third aspects, the TCI state activation/deactivation request message indicates at least one of a candidate cell ID, one or more TCI states associated with the candidate cell ID, one or more joint/separate TCI state indicators associated with the one or more TCI states, one or more downlink/joint TCI state or uplink TCI state indicators associated with the one or more TCI states, or one or more activation/deactivation indicators associated with the one or more TCI states.

In a fifth aspect, alone or in combination with one or more of the first through fourth aspects, receiving the at least one of the TCI state activation/deactivation request message or the TCI state activation/deactivation notification message includes receiving the TCI state activation/deactivation notification message.

In a sixth aspect, alone or in combination with one or more of the first through fifth aspects, the TCI state activation/deactivation notification message is associated with a MAC-CE.

In a seventh aspect, alone or in combination with one or more of the first through sixth aspects, receiving the TCI state activation/deactivation notification message includes receiving the TCI state activation/deactivation notification message in response to the UE activating or deactivating the at least one TCI state.

In an eighth aspect, alone or in combination with one or more of the first through seventh aspects, the TCI state activation/deactivation notification message indicates at least one of one or more candidate cell IDs, one or more TCI states associated with each of the one or more candidate cell IDs, or one or more activation/deactivation indicators associated with the one or more TCI states associated with each of the one or more candidate cell IDs.

In a ninth aspect, alone or in combination with one or more of the first through eighth aspects, process 600 includes transmitting, to the UE, configuration information that enables at least one of activation or deactivation of the at least one TCI state by the UE without transmission of the TCI state activation/deactivation request message, or transmission of the TCI state activation/deactivation notification message by the UE.

In a tenth aspect, alone or in combination with one or more of the first through ninth aspects, the TCI state activation/deactivation MAC-CE confirms activation or deactivation of the at least one TCI state by indicating the same TCI state information as the TCI state information indicated by the TCI state activation/deactivation notification message.

In an eleventh aspect, alone or in combination with one or more of the first through tenth aspects, the TCI state activation/deactivation MAC-CE indicates different TCI state information than the TCI state information indicated by the TCI state activation/deactivation notification message, and the process 600 further comprises at least one of indicating that the UE is to activate one or more TCI states that were not indicated by the TCI state activation/deactivation notification message by including the one or more TCI states in the TCI state activation/deactivation MAC-CE, or indicating that the UE is to deactivate one or more TCI states indicated by the TCI state activation/deactivation notification message by omitting the one or more TCI states in the TCI state activation/deactivation MAC-CE.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIG. 4. Additionally, or alternatively, the apparatus 700 may be configured to perform one or more processes described herein, such as process 500 of FIG. 5. In some aspects, the apparatus 700 and/or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The transmission component 704 may transmit at least one of a TCI state activation/deactivation request message or a TCI state activation/deactivation notification message. The communication manager 706 may activate or deactivate at least one TCI state associated with a C-LTM procedure based at least in part on the at least one of the TCI state activation/deactivation request message or the TCI state activation/deactivation notification message.

The reception component 702 may receive, in response to transmitting the TCI state activation/deactivation request message, a TCI state activation/deactivation MAC-CE indicating that one or more TCI states are to be activated or deactivated.

The reception component 702 may receive configuration information that enables at least one of activation or deactivation of the at least one TCI state without transmission of the TCI state activation/deactivation request message, or transmission of the TCI state activation/deactivation notification message.

The reception component 702 may receive, in response to transmitting the TCI state activation/deactivation notification message, a TCI state MAC-CE.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication, in accordance with the present disclosure. The apparatus 800 may be a network node, or a network node may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIG. 4. Additionally, or alternatively, the apparatus 800 may be configured to perform one or more processes described herein, such as process 600 of FIG. 6. In some aspects, the apparatus 800 and/or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 and/or the transmission component 804 may include or may be included in a network interface. The network interface may be configured to obtain and/or output signals for the apparatus 800 via one or more communications links, such as a backhaul link, a midhaul link, and/or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive, from a UE, at least one of a TCI state activation/deactivation request message or a TCI state activation/deactivation notification message, wherein the at least one of the TCI state activation/deactivation request message or the TCI state activation/deactivation notification message is associated with the UE activating or deactivating at least one TCI state associated with a C-LTM procedure. The transmission component 804 may transmit, in response to receiving the at least one of the TCI state activation/deactivation request message or the TCI state activation/deactivation notification message, a TCI state activation/deactivation MAC-CE associated with the UE activating or deactivating the at least one TCI state associated with the C-LTM procedure.

The transmission component 804 may transmit, to the UE, configuration information that enables at least one of activation or deactivation of the at least one TCI state by the UE without transmission of the TCI state activation/deactivation request message, or transmission of the TCI state activation/deactivation notification message by the UE.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: transmitting at least one of a transmission configuration indicator (TCI) state activation/deactivation request message or a TCI state activation/deactivation notification message; and activating or deactivating at least one TCI state associated with a conditional lower layer triggered mobility (C-LTM) procedure based at least in part on the at least one of the TCI state activation/deactivation request message or the TCI state activation/deactivation notification message.

Aspect 2: The method of Aspect 1, wherein transmitting that at least one of the TCI state activation/deactivation request message or the TCI state activation/deactivation notification message includes transmitting the TCI state activation/deactivation request message.

Aspect 3: The method of Aspect 2, wherein the TCI state activation/deactivation request message is associated with a medium access control (MAC) control element (MAC-CE).

Aspect 4: The method of any of Aspects 1-2, further comprising receiving, in response to transmitting the TCI state activation/deactivation request message, a TCI state activation/deactivation medium access control (MAC) control element (MAC-CE) indicating that one or more TCI states are to be activated or deactivated.

Aspect 5: The method of any of Aspects 1-2, wherein the TCI state activation/deactivation request message indicates at least one of: a candidate cell identifier (ID), one or more TCI states associated with the candidate cell ID, one or more joint/separate TCI state indicators associated with the one or more TCI states, one or more downlink/joint TCI state or uplink TCI state indicators associated with the one or more TCI states, or one or more activation/deactivation indicators associated with the one or more TCI states.

Aspect 6: The method of Aspect 1, wherein transmitting the at least one of the TCI state activation/deactivation request message or the TCI state activation/deactivation notification message includes transmitting the TCI state activation/deactivation notification message.

Aspect 7: The method of Aspect 6, wherein the TCI state activation/deactivation notification message is associated with a medium access control (MAC) control element (MAC-CE).

Aspect 8: The method of any of Aspects 6-7, wherein transmitting the TCI state activation/deactivation notification message includes transmitting the TCI state activation/deactivation notification message in response to activating or deactivating the at least one TCI state.

Aspect 9: The method of any of Aspects 6-8, wherein the TCI state activation/deactivation notification message indicates at least one of: one or more candidate cell identifiers (IDs), one or more TCI states associated with each of the one or more candidate cell IDs, or one or more activation/deactivation indicators associated with the one or more TCI states associated with each of the one or more candidate cell IDs.

Aspect 10: The method of any of Aspects 6-9, further comprising receiving configuration information that enables at least one of: activation or deactivation of the at least one TCI state without transmission of the TCI state activation/deactivation request message, or transmission of the TCI state activation/deactivation notification message.

Aspect 11: The method of any of Aspects 6-10, further comprising receiving, in response to transmitting the TCI state activation/deactivation notification message, a TCI state activation/deactivation medium access control (MAC) control element (MAC-CE).

Aspect 12: The method of Aspect 11, wherein the TCI state activation/deactivation MAC-CE confirms activation or deactivation of the at least one TCI state by indicating same TCI state information as TCI state information indicated by the TCI state activation/deactivation notification message.

Aspect 13: The method of Aspect 11, wherein the TCI state activation/deactivation MAC-CE indicates different TCI state information than TCI state information indicated by the TCI state activation/deactivation notification message, and wherein the method further comprises at least one of: activating one or more TCI states indicated by the TCI state activation/deactivation MAC-CE that were not indicated by the TCI state activation/deactivation notification message, or deactivating one or more TCI states indicated by the TCI state activation/deactivation notification message that were not indicated by the TCI state activation/deactivation MAC-CE.

Aspect 14: A method of wireless communication performed by a network node, comprising: receiving, from a user equipment (UE), at least one of a transmission configuration indicator (TCI) state activation/deactivation request message or a TCI state activation/deactivation notification message, wherein the at least one of the TCI state activation/deactivation request message or the TCI state activation/deactivation notification message is associated with the UE activating or deactivating at least one TCI state associated with a conditional lower layer triggered mobility (C-LTM) procedure; and transmitting, in response to receiving the at least one of the TCI state activation/deactivation request message or the TCI state activation/deactivation notification message, a TCI state activation/deactivation medium access control (MAC) control element (MAC-CE) associated with the UE activating or deactivating the at least one TCI state associated with the C-LTM procedure.

Aspect 15: The method of Aspect 14, wherein receiving that at least one of the TCI state activation/deactivation request message or the TCI state activation/deactivation notification message includes receiving the TCI state activation/deactivation request message.

Aspect 16: The method of Aspect 15, wherein the TCI state activation/deactivation request message is associated with a MAC-CE.

Aspect 17: The method of any of Aspects 15-16, wherein the TCI state activation/deactivation MAC-CE indicates one or more TCI states that are to be activated or deactivated.

Aspect 18: The method of any of Aspects 15-17, wherein the TCI state activation/deactivation request message indicates at least one of: a candidate cell identifier (ID), one or more TCI states associated with the candidate cell ID, one or more joint/separate TCI state indicators associated with the one or more TCI states, one or more downlink/joint TCI state or uplink TCI state indicators associated with the one or more TCI states, or one or more activation/deactivation indicators associated with the one or more TCI states.

Aspect 19: The method of Aspect 14, wherein receiving the at least one of the TCI state activation/deactivation request message or the TCI state activation/deactivation notification message includes receiving the TCI state activation/deactivation notification message.

Aspect 20: The method of Aspect 19, wherein the TCI state activation/deactivation notification message is associated with a MAC-CE.

Aspect 21: The method of any of Aspects 19-20, wherein receiving the TCI state activation/deactivation notification message includes receiving the TCI state activation/deactivation notification message in response to the UE activating or deactivating the at least one TCI state.

Aspect 22: The method of any of Aspects 19-21, wherein the TCI state activation/deactivation notification message indicates at least one of: one or more candidate cell identifiers (IDs), one or more TCI states associated with each of the one or more candidate cell IDs, or one or more activation/deactivation indicators associated with the one or more TCI states associated with each of the one or more candidate cell IDs.

Aspect 23: The method of any of Aspects 19-22, further comprising transmitting, to the UE, configuration information that enables at least one of: activation or deactivation of the at least one TCI state by the UE without transmission of the TCI state activation/deactivation request message, or transmission of the TCI state activation/deactivation notification message by the UE.

Aspect 24: The method of any of Aspects 19-23, wherein the TCI state activation/deactivation MAC-CE confirms activation or deactivation of the at least one TCI state by indicating same TCI state information as TCI state information indicated by the TCI state activation/deactivation notification message.

Aspect 25: The method of any of Aspects 19-23, wherein the TCI state activation/deactivation MAC-CE indicates different TCI state information than TCI state information indicated by the TCI state activation/deactivation notification message, and wherein the method further comprises at least one of: indicating that the UE is to activate one or more TCI states that were not indicated by the TCI state activation/deactivation notification message by including the one or more TCI states in the TCI state activation/deactivation MAC-CE, or indicating that the UE is to deactivate one or more TCI states indicated by the TCI state activation/deactivation notification message by omitting the one or more TCI states in the TCI state activation/deactivation MAC-CE.

Aspect 26: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-25.

Aspect 27: An apparatus for wireless communication at a device, the apparatus comprising one or more memories and one or more processors coupled to the one or more memories, the one or more processors configured to cause the device to perform the method of one or more of Aspects 1-25.

Aspect 28: An apparatus for wireless communication, the apparatus comprising at least one means for performing the method of one or more of Aspects 1-25.

Aspect 29: A non-transitory computer-readable medium storing code for wireless communication, the code comprising instructions executable by one or more processors to perform the method of one or more of Aspects 1-25.

Aspect 30: A non-transitory computer-readable medium storing a set of instructions for wireless communication, the set of instructions comprising one or more instructions that, when executed by one or more processors of a device, cause the device to perform the method of one or more of Aspects 1-25.

Aspect 31: A device for wireless communication, the device comprising a processing system that includes one or more processors and one or more memories coupled with the one or more processors, the processing system configured to cause the device to perform the method of one or more of Aspects 1-25.

Aspect 32: An apparatus for wireless communication at a device, the apparatus comprising one or more memories and one or more processors coupled to the one or more memories, the one or more processors individually or collectively configured to cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, which are configured, individually or in any combination, to:
transmit at least one of a transmission configuration indicator (TCI) state activation/deactivation request message or a TCI state activation/deactivation notification message; and
activate or deactivate at least one TCI state associated with a conditional lower layer triggered mobility (C-LTM) procedure based at least in part on the at least one of the TCI state activation/deactivation request message or the TCI state activation/deactivation notification message.

2. The UE of claim 1, wherein the one or more processors, to transmit that at least one of the TCI state activation/deactivation request message or the TCI state activation/deactivation notification message, are configured, individually or in any combination, to transmit the TCI state activation/deactivation request message.

3. The UE of claim 2, wherein the TCI state activation/deactivation request message is associated with a medium access control (MAC) control element (MAC-CE).

4. The UE of claim 2, wherein the one or more processors are further configured, individually or in any combination, to receive, in response to transmitting the TCI state activation/deactivation request message, a TCI state activation/deactivation medium access control (MAC) control element (MAC-CE) indicating that one or more TCI states are to be activated or deactivated.

5. The UE of claim 2, wherein the TCI state activation/deactivation request message indicates at least one of:
a candidate cell identifier (ID),
one or more TCI states associated with the candidate cell ID,
one or more joint/separate TCI state indicators associated with the one or more TCI states,
one or more downlink/joint TCI state or uplink TCI state indicators associated with the one or more TCI states, or
one or more activation/deactivation indicators associated with the one or more TCI states.

6. The UE of claim 1, wherein the one or more processors, to transmit the at least one of the TCI state activation/deactivation request message or the TCI state activation/deactivation notification message, are configured, individually or in any combination, to transmit the TCI state activation/deactivation notification message.

7. The UE of claim 6, wherein the TCI state activation/deactivation notification message is associated with a medium access control (MAC) control element (MAC-CE).

8. The UE of claim 6, wherein the one or more processors, to transmit the TCI state activation/deactivation notification message, are configured, individually or in any combination, to transmit the TCI state activation/deactivation notification message in response to activating or deactivating the at least one TCI state.

9. The UE of claim 6, wherein the TCI state activation/deactivation notification message indicates at least one of:
one or more candidate cell identifiers (IDs),
one or more TCI states associated with each of the one or more candidate cell IDs, or
one or more activation/deactivation indicators associated with the one or more TCI states associated with each of the one or more candidate cell IDs.

10. The UE of claim 6, wherein the one or more processors are further configured, individually or in any combination, to receive configuration information that enables at least one of:
activation or deactivation of the at least one TCI state without transmission of the TCI state activation/deactivation request message, or
transmission of the TCI state activation/deactivation notification message.

11. The UE of claim 6, wherein the one or more processors are further configured, individually or in any combination, to receive, in response to transmitting the TCI state activation/deactivation notification message, a TCI state activation/deactivation medium access control (MAC) control element (MAC-CE).

12. The UE of claim 11, wherein the TCI state activation/deactivation MAC-CE confirms activation or deactivation of the at least one TCI state by indicating same TCI state information as TCI state information indicated by the TCI state activation/deactivation notification message.

13. The UE of claim 11, wherein the TCI state activation/deactivation MAC-CE indicates different TCI state information than TCI state information indicated by the TCI state activation/deactivation notification message, and
wherein the one or more processors are further configured, individually or in any combination, to:
activate one or more TCI states indicated by the TCI state activation/deactivation MAC-CE that were not indicated by the TCI state activation/deactivation notification message, or
deactivate one or more TCI states indicated by the TCI state activation/deactivation notification message that were not indicated by the TCI state activation/deactivation MAC-CE.

14. A method of wireless communication performed by a user equipment (UE), comprising:
transmitting at least one of a transmission configuration indicator (TCI) state activation/deactivation request message or a TCI state activation/deactivation notification message; and
activating or deactivating at least one TCI state associated with a conditional lower layer triggered mobility (C-LTM) procedure based at least in part on the at least one of the TCI state activation/deactivation request message or the TCI state activation/deactivation notification message.

15. The method of claim 14, wherein transmitting that at least one of the TCI state activation/deactivation request message or the TCI state activation/deactivation notification message includes transmitting the TCI state activation/deactivation request message.

16. The method of claim 15, further comprising receiving, in response to transmitting the TCI state activation/deactivation request message, a TCI state activation/deactivation medium access control (MAC) control element (MAC-CE) indicating that one or more TCI states are to be activated or deactivated.

17. The method of claim 14, wherein transmitting the at least one of the TCI state activation/deactivation request message or the TCI state activation/deactivation notification message includes transmitting the TCI state activation/deactivation notification message.

18. The method of claim 17, further comprising receiving, in response to transmitting the TCI state activation/deactivation notification message, a TCI state activation/deactivation medium access control (MAC) control element (MAC-CE).

19. The method of claim 18, wherein the TCI state activation/deactivation MAC-CE indicates different TCI state information than TCI state information indicated by the TCI state activation/deactivation notification message, and
wherein the method further comprises at least one of:
activating one or more TCI states indicated by the TCI state activation/deactivation MAC-CE that were not indicated by the TCI state activation/deactivation notification message, or
deactivating one or more TCI states indicated by the TCI state activation/deactivation notification message that were not indicated by the TCI state activation/deactivation MAC-CE.

20. A non-transitory computer-readable medium storing a set of instructions for wireless communication, the set of instructions comprising:
one or more instructions that, when executed by one or more processors of a user equipment (UE), cause the UE to:
transmit at least one of a transmission configuration indicator (TCI) state activation/deactivation request message or a TCI state activation/deactivation notification message; and
activate or deactivating at least one TCI state associated with a conditional lower layer triggered mobility (C-LTM) procedure based at least in part on the at least one of the TCI state activation/deactivation request message or the TCI state activation/deactivation notification message.
